(19) United States
(12) Patent Application Publication
(10) Pub. No.: US 2015/0107918 A1
(43) Pub. Date: Apr. 23, 2015

(54) PNEUMATIC VEHICLE AND PNEUMATIC DRIVING MODULE

(71) Applicant: National Taiwan Normal University, Taipei City (TW)

(72) Inventors: Yi-Hsuan HUNG, Taipei City (TW); Yu-Xuan LIN, Yilan City (TW); Jian-Hao CHEN, Wujie Township (TW)

(73) Assignee: National Taiwan Normal University, Taipei City (TW)

(21) Appl. No.: 14/173,984

(22) Filed: Feb. 6, 2014

(30) Foreign Application Priority Data
Oct. 23, 2013 (TW) 102138246

(51) Int. Cl. B60K 7/00; B60K 3/02

(52) U.S. Cl. CPC B60K 7/0023; B60K 3/02
USPC 180/55

(57) ABSTRACT

A pneumatic driving module is for mounting on and driving a vehicle. The vehicle includes at least one wheel that includes a rim. The pneumatic driving module includes a storage tank, an air delivery unit and an air-driving mechanism. The storage tank is for storing compressed air therein. The air delivery unit includes a tube fluidly communicating with the storage tank for discharging the compressed air stored in the storage tank. The air-driving mechanism fluidly communicates with the tube, and is configured to be mounted directly to the wheel for providing dynamic energy associated with the compressed air to the rim to drive rotation of the wheel.

### CROSS REFERENCE TO RELATED APPLICATION

This application claims priority of Taiwanese application No. 102138246, filed on Oct. 23, 2013.

### BACKGROUND OF THE INVENTION

1. Field of the Invention

The invention relates to a pneumatic vehicle, more particularly to a pneumatic vehicle capable of converting compressed air into dynamic energy in a relatively efficient manner.

2. Description of the Related Art

A conventional pneumatic vehicle usually includes a plurality of wheels and a pneumatic driving module. The conventional pneumatic driving module includes a storage tank, a pneumatic motor, a tube, a speed change gearbox and a plurality of transmission shafts. The storage tank is for storing compressed air therein, and communicates fluidly with the pneumatic motor via the tube.

The speed change gearbox is connected between an output shaft of the pneumatic motor and the transmission shafts to transmit to the transmission shafts dynamic energy generated by the pneumatic motor using the compressed air so as to rotate the transmission shafts and the wheels that are respectively and co-rotatably connected to the transmission shafts, thereby driving the conventional pneumatic vehicle.

However, a great amount of energy is lost during transmission of the dynamic power, which adversely affects efficiency of energy conversion and endurance of the conventional pneumatic vehicle.

Further, the pneumatic motor and the speed change gearbox occupy a relatively large space in the conventional pneumatic vehicle, and increase weight and manufacturing costs for the conventional pneumatic vehicle.

### SUMMARY OF THE INVENTION

Therefore, the object of the present invention is to provide a pneumatic vehicle capable of converting compressed air into dynamic energy to drive a rim of a wheel of the pneumatic vehicle.

According to the present invention, there is provided a pneumatic driving module for mounting on and driving a vehicle. The vehicle includes at least one wheel that includes a rim. The pneumatic driving module comprises a storage tank, an air delivery unit and an air-driving mechanism. The storage tank is for storing compressed air therein. The air delivery unit includes a tube that fluidly communicates with the storage tank for discharging the compressed air stored in the storage tank. The air-driving mechanism fluidly communicates with the tube of the air delivery unit, and is configured to be mounted directly to the wheel for providing dynamic energy associated with the compressed air to the rim of the wheel to drive rotation of the wheel.

According to another aspect of the present invention, there is provided a pneumatic vehicle comprising a frame, at least one wheel rotatably mounted to the frame and including a rim, and a pneumatic driving module mounted directly to the wheel for driving rotation of the wheel. The pneumatic driving module includes a storage tank, an air delivery unit and an air-driving mechanism. The storage tank is for storing compressed air therein. The air delivery unit includes a tube that fluidly communicates with the storage tank for discharging the compressed air stored in the storage tank. The air-driving mechanism fluidly communicates with the tube of the air delivery unit, and is configured to be mounted directly to the wheel for providing dynamic energy associated with the compressed air to the rim of the wheel to drive rotation of the wheel.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic top view of a pneumatic vehicle according to a first preferred embodiment of the present invention;

FIG. 2 is a schematic sectional view of a pneumatic driving module according to the first preferred embodiment;

FIG. 3 is a schematic side view of a wheel of the pneumatic vehicle;

FIG. 4 is a partly sectional schematic side view of the wheel of the first preferred embodiment;

FIG. 5 is a schematic perspective view of the wheel; and

FIG. 6 is a schematic side view of a wheel and an air-driving mechanism of the pneumatic driving module according to a second preferred embodiment of the present invention.

### DETAILED DESCRIPTION OF THE PREFERRED EMBODIMENTS

Before the present invention is described in greater detail, it should be noted that like reference numerals are used to indicate corresponding or analogous elements throughout the accompanying disclosure.

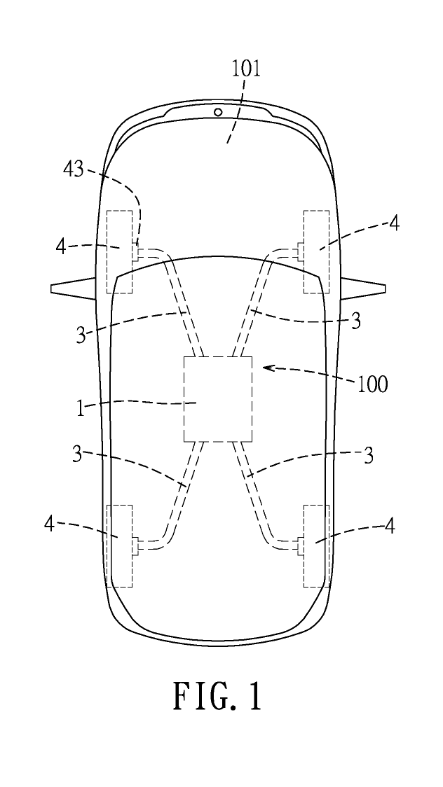

Referring to FIG. 1, the pneumatic vehicle according to a first preferred embodiment of the present invention is shown to include a frame 101, four wheels 4, and a pneumatic driving module 100. The pneumatic driving module 100 is mounted directly to the wheels 4 for driving rotation of the wheels 4. Note that the number of the wheels 4 is not limited to what is disclosed herein. For example, a bicycle or an eight-wheeled truck may be applied in other embodiments of this invention.

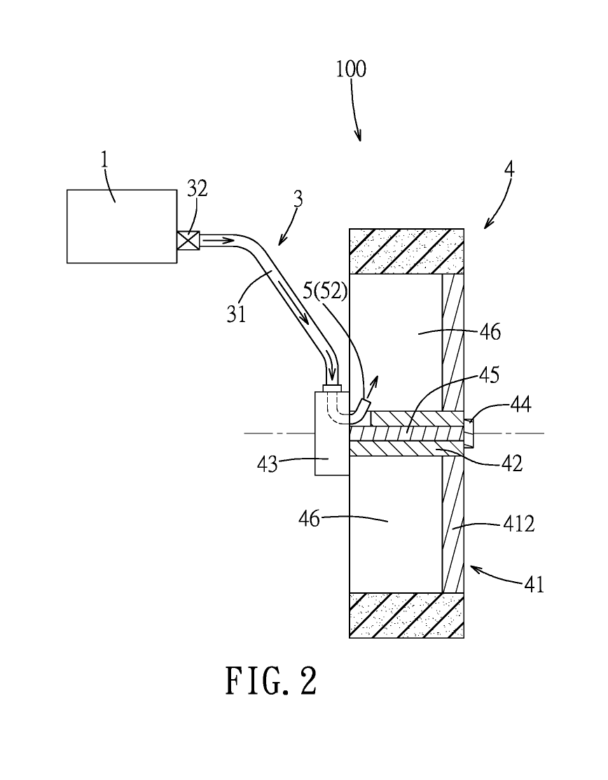

Further referring to FIG. 2, the wheel 4 includes a rim 41, a mounting member 43, a limiting member 44 and a shaft 45. The rim 41 includes a hub 42, a plurality of blades 46 extending radially and outwardly from the hub 42, and a rim disk 412 connected fixedly to the hub 42. The mounting member 43 is mounted fixedly to the frame 101 of the pneumatic vehicle. The shaft 45 extends non-rotatably from the mounting member 43 through the hub 42, so that the wheel 4 is rotatable with respect to the frame 101 about the shaft 45. The limiting member 44 is detachably connected to the shaft 45 opposite to the mounting member 43 for preventing removal of the wheel 4 from the frame 101.

The pneumatic driving module 100 includes a storage tank 1, four air delivery units 3, and four air-driving mechanisms 5. A combination of one of the air delivery units s 3 and a corresponding one of the air-driving mechanisms 5 corresponds to a respective one of the wheels 4. It should be appreciated that, in a case where the number of the wheels 4 of the pneumatic vehicle is not equal to four, the number of the air delivery units s 3 and the number of the air-driving mechanisms 5 should conform with the number of the wheels 4. Since the structural relationship among the air delivery units s 3, the air-driving mechanisms 5 and the wheels 4 are identical, only one of the air delivery units s 3, the corresponding one of the air-driving mechanisms 5 and the respective one of the wheels 4 will be illustrated in the following description for the sake of brevity.

The storage tank 1 is for storing compressed air therein. The air delivery unit 3 includes a tube 31 and a control valve 32. The tube 31 fluidly communicates with the storage tank 1 for discharging the compressed air stored in the storage tank 1. The control valve 32 is mounted between the storage tank 1 and the tube 31, and is operable for controlling amount of the compressed air flowing from the storage tank 1 into the tube 31.

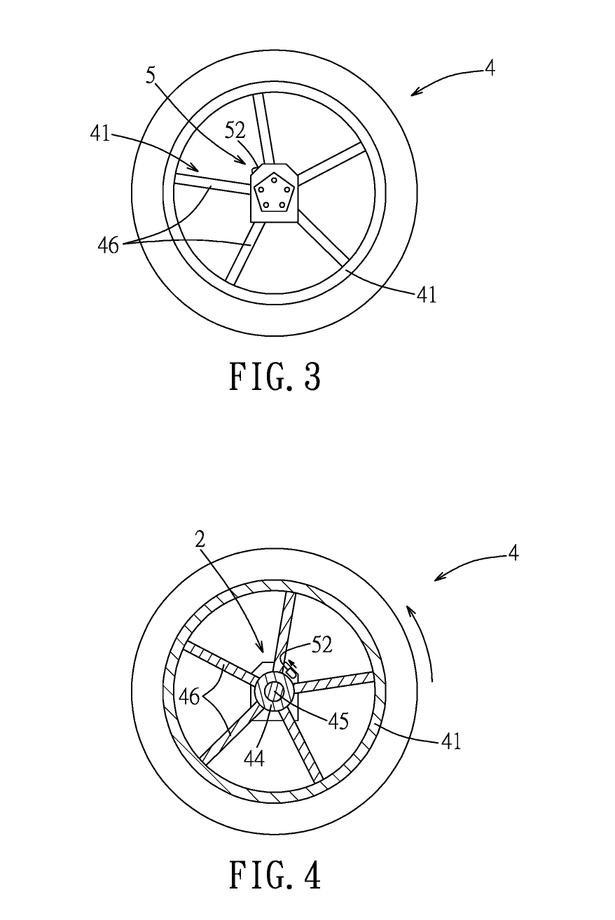

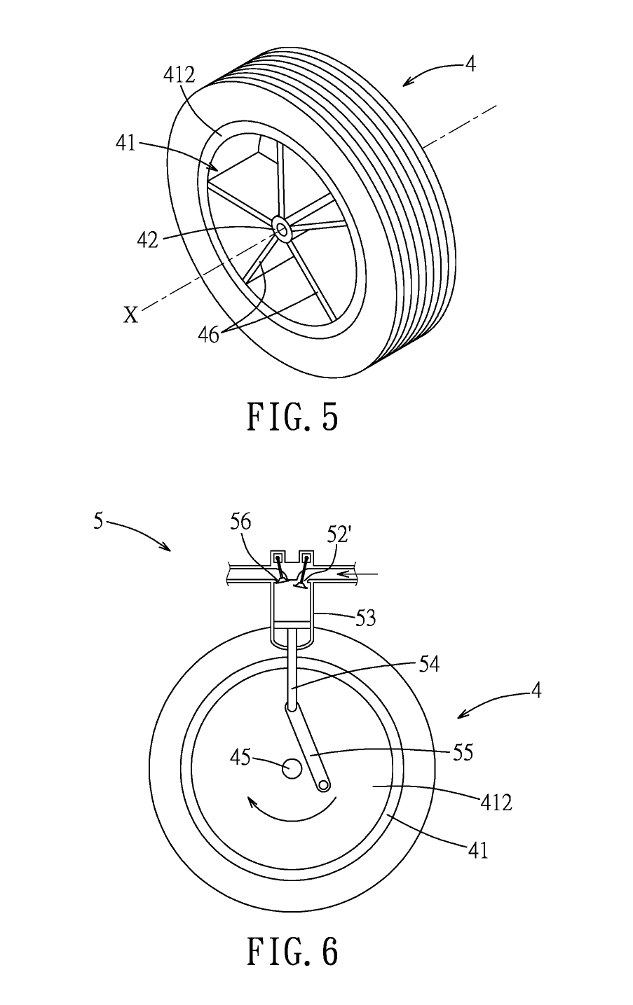

Further referring to FIGS. 3 to 5, the air-driving mechanism 5 includes an air outlet 52 that fluidly communicates with the tube 31 and that is disposed adjacent to the hub 42 for guiding the compressed air directly to the blades 46, such that dynamic energy associated with the compressed air is provided to the rim 41 to rotate the wheel 4 about the shaft 45 . A discharge direction of the compressed air discharged from the air outlet 52 is parallel to an imaginary line tangent to a periphery of the wheel 4. Preferable, the hub 42 and the blades 46 are integrally formed.

To enable movement of the pneumatic vehicle, the compressed air stored in the storage tank 1 flows through the tube 31 and is discharged to the blades 46, and the blades 46 of the rim 41 are thus directly driven to rotate about the shaft 45. To change the speed of the pneumatic vehicle, the amount of the compressed air that flows into the tube 31 can be controlled using the control valve 32 as desired. Additionally, it is relatively convenient to replace the wheel 4 as required by removing the limiting member 44 from the shaft 45 as compared to the conventional pneumatic vehicle.

Referring to FIG. 6, the pneumatic vehicle according to a second preferred embodiment of the present invention is shown. In this embodiment, the air-driving mechanism 5 includes an air outlet 52′, a cylinder 53, a piston 54, a connecting rod 55, and an exhaust channel 56. The air outlet 52′ fluidly communicates with the tube 31 (see FIG. 2). The cylinder 53 fluidly communicates with the air outlet 52′ for receiving the compressed air therefrom. The piston 54 is movably disposed in the cylinder 53 and is configured to be moved by the compressed air injected into the cylinder 53. The exhaust channel 56 fluidly communicates with the cylinder 53 for expelling the compressed air from the air outlet 52′ after the piston 54 is moved. The connecting rod 55 is connected to the piston 54 and is articulated to the rim disk 412 for transmitting power from the piston 54 to the wheel 4 so as to drive rotation of the wheel 4.

It should be noted that the air-driving mechanism 5 is not limited to the specific structures disclosed herein.

To sum up, by virtue of the pneumatic driving module 100, the rim 41 of the wheel 4 of the pneumatic vehicle according to the present invention can be driven to rotate about the transmission shaft 45 without the use of the pneumatic motor, the speed change gearbox and the transmission shafts, thus converting the compressed air into dynamic energy in a relatively effective manner. Further, the volume, the weight, and the manufacturing cost of the pneumatic vehicle according to the present invention can be reduced since some cumbersome elements, such as the pneumatic motor and the speed change gearbox, are not required.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A pneumatic driving module for mounting on and driving a vehicle, the vehicle including at least one wheel that includes a rim, said pneumatic driving module comprising:
a storage tank for storing compressed air therein;
an air delivery unit including a tube that fluidly communicates with said storage tank for discharging the compressed air stored in said storage tank; and
an air-driving mechanism fluidly communicating with said tube of said air delivery unit, and configured to be mounted directly to the wheel for providing dynamic energy associated with the compressed air to the rim of the wheel to drive rotation of the wheel.

2. The pneumatic driving module as claimed in claim 1, the rim of the wheel including a hub and a plurality of blades extending radially and outwardly from the hub,
wherein said air-driving mechanism includes an air outlet that fluidly communicates with said tube and that is configured to be disposed adjacent to the hub for guiding the compressed air directly to the blades, and a discharge direction of the compressed air discharged from said air outlet is parallel to an imaginary line tangent to a periphery of the wheel.

3. The pneumatic driving module as claimed in claim 1,
wherein said air delivery unit further includes a control valve mounted between said storage tank and said tube, and operable for controlling amount of compressed air flowing from said storage tank into said tube.

4. The pneumatic driving module as claimed in claim 1, the rim of the wheel including a rim disk,
wherein said air-driving mechanism includes an air outlet that fluidly communicates with said tube, a cylinder fluidly communicating with said air outlet for receiving the compressed air therefrom, a piston movably disposed in said cylinder and configured to be moved by the compressed air injected into said cylinder, and a connecting rod connected to said piston and configured to be articulated to the rim disk of the wheel for transmitting power from said piston to the wheel so as to drive rotation of the wheel.

5. A pneumatic vehicle comprising a frame, at least one wheel rotatably mounted to said frame and including a rim, and a pneumatic driving module mounted directly to said wheel for driving rotation of said wheel, said pneumatic driving module including:
a storage tank for storing compressed air therein;
an air delivery unit including a tube that fluidly communicates with said storage tank for discharging the compressed air stored in said storage tank; and
an air-driving mechanism fluidly communicating with said tube of said air delivery unit, and mounted directly to said wheel for providing dynamic energy associated with the compressed air to said rim of said wheel to drive rotation said wheel.

6. The pneumatic vehicle as claimed in claim 5, wherein said rim includes a hub, and a plurality of blades extending radially and outwardly from said hub.

7. The pneumatic vehicle as claimed in claim 6, wherein said air-driving mechanism includes an air outlet that fluidly communicates with said tube and that is disposed adjacent to said hub for guiding the compressed air directly to said blades, and a discharge direction of the compressed air discharged from said air outlet is parallel to an imaginary line tangent to a periphery of the wheel.

8. The pneumatic vehicle as claimed in claim 6, wherein said blades and said hub are integrally formed.

9. The pneumatic vehicle as claimed in claim 6, wherein said wheel further includes a mounting member mounted to said frame, a shaft extending from said mounting member through said hub, and a limiting member detachably connected to said shaft opposite to said mounting member to prevent removal of said wheel from said mounting member.

10. The pneumatic vehicle as claimed in claim 5, wherein said air delivery unit further includes a control valve mounted between said storage tank and said tube, and operable for controlling amount of compressed air flowing from said storage tank into said tube.

11. The pneumatic vehicle as claimed in claim 5, wherein said rim of said wheel includes a rim disk, and
wherein said air-driving mechanism includes an air outlet that fluidly communicates with said tube, a cylinder fluidly communicating with said air outlet for receiving the compressed air therefrom, a piston movably disposed in said cylinder and configured to be moved by the compressed air injected into said cylinder, and a connecting rod connected to said piston and articulated to said rim disk for transmitting power from said piston to said wheel so as to drive rotation of said wheel.
